(19) United States
(12) Patent Application Publication
(10) Pub. No.: US 2025/0237620 A1
(43) Pub. Date: Jul. 24, 2025

(54) DETECTION SYSTEM AND METHOD

(71) Applicant: Purdue Research Foundation, West Lafayette, IN (US)

(72) Inventor: Aaron James Specht, West Lafayette, IN (US)

(73) Assignee: Purdue Research Foundation, West Lafayette, IN (US)

(21) Appl. No.: 19/033,121

(22) Filed: Jan. 21, 2025

Related U.S. Application Data
(60) Provisional application No. 63/623,422, filed on Jan. 22, 2024.

(51) Int. Cl. G01N 23/223

(52) U.S. Cl. CPC G01N 23/223; G01N 2223/303; G01N 2223/313; G01N 2223/316

(57) ABSTRACT

The detection system includes an x-ray fluorescence (XRF) device, a filter card, and a radiation detector. The XRF device having an x-ray tube including an x-ray source and an anode. The x-ray source is configured to produce an x-ray beam. The filter card is disposed along a path of the x-ray beam. A sample may be disposed on the filter card to be measured by the detection system. The radiation detector is coupled to the XRF device. In certain circumstances, the detection system includes a vacuum chamber, a vacuum pump, and a light element detector.

### CROSS REFERENCE TO RELATED APPLICATIONS

This application claims the benefit of U.S. Provisional Application No. 63/623,422 filed Jan. 22, 2024, the entirety of which is hereby incorporated by reference.

### GOVERNMENT RIGHTS

This invention was made with government support under AG009740 awarded by the National Institutes of Health. The government has certain rights in the invention.

### FIELD

The disclosure generally relates to detection systems and, more particularly, to systems configured to identify and/or quantify certain elements in a material.

### INTRODUCTION

This section provides background information related to the present disclosure which is not necessarily prior art.

The gold standard for capillary blood lead testing is analysis by either graphite furnace atomic absorption spectrometry (GFAAS) or inductively coupled mass spectrometry (ICP-MS). These analyses are performed with costly instruments that require expertise to operate and maintain, and are designated high-complexity tests by the U.S. Food and Drug Administration (FDA). Most health departments, clinical laboratories, or health services have little or no laboratory capacity for blood lead tests using GFAAS or ICP-MS methods. Using anodic stripping voltammetry (ASV), a point-of-care reagent-based test, there is success to a lower limit of close to 3.5 ug/dL, which would make it inadequate for surveillance or identification of those close to the CDC actionable lead level which happens to be the same. In addition, safety concerns resulted in a recent recall of a widely used family of these instruments. A point that also stands in much scientific literature as many lead testing kits are known to have higher readings compared to venipuncture tests.

X-ray fluorescence (XRF) has been used for decades for elemental quantification. XRF fluorescence operates by irradiating a sample, ejecting an inner shell electron, which creates a cascading effect to fill in the inner shell orbital and release an x-ray of energy specific to the element of that atom. By collecting these x-rays, a concentration can be determined based on the number of counts at a particular energy specific to that element-10.55 and 12.61 keV are the predominant energies used for lead. Thus, the measurement of a particular element only depends on the ability to collect counts of these energies over a necessary background from any potential source radiation. Importantly, XRF thus allows for multi-elemental monitoring simultaneously alongside a measurement of lead. The number of counts will depend on the medium in which the x-rays arise and the density of lead signals able to reach the detector.

The need for blood collection has been a traditional roadblock to the expansion of widespread testing in many communities. An alternative field-friendly approach for blood metal analysis is to collect capillary blood spots using filter card. Blood spot collection has become more widespread with their use in DNA measures. There have been attempts to use dried blood spots in lead screening as an alternative approach to measuring venous blood lead levels, but these attempts previously failed. The benefit of using filter paper is the samples can be collected in the field, stored at ambient temperatures, and then analyzed at a later date. However, the previously tried analysis methods require some form of digestion of a small punch from the blood spot or laser ablation to quantify the metal in a small part of the blood spot. These sampling techniques fail with the influence of hematocrit level-changing the dynamics of blood wicking and drying and therefore causing variation in metal concentration depending on where in the spot is sampled. A major benefit of XRF is the ability to sample over a wider area at once. Thus, we would eliminate the difficulties in sampling dried blood spots by our ability to use the spot as-is without further manipulation or dependencies on the many other variable influencing typical measurements using this medium.

XRF has also been used in the past to look at biologic tissues including whole blood, serum, and other tissue samples although typically with rather high detection limits. XRF has been utilized to analyze metals in blood spots, but has primarily not focused on trace metals like Pb because of the high detection limits, and instead considered metals such as Ca, Cu, and Zn that are found at much higher concentrations. Advances in technology, however, have substantially reduced the detection limits for XRF. XRF has many advantages over other approaches, including ease of sample preparation and analysis, which reduces the need for complicated equipment expertise, reduces the consumable costs, and reduces the time needed for analyses. Importantly, XRF offers the tremendous benefit of a non-destructive analysis that can measure over a wide area, such as an entire blood spot, which reduces the potential biases from hematocrit induced variation in metal concentrations across the blood spot. Furthermore, XRF has steadily improved both in size and functionality due to drastic improvements in detector and x-ray generator capabilities.

Current methodology exists in x-ray fluorescence equipment for measurement of blood lead which operates at 15-watt x-ray tube output and uses a 30-minute measurement time and achieves a detection limit of 1 ug/dL. Known devices for these measurements can be improved by 1) increasing the output from the x-ray tube source; 2) reducing the burden of unnecessary components adding to overall cost; 3) tailoring the overall formfactor of the device for point-of-care settings. The current system operates at 15-watt x-ray tube output and uses a 30-minute measurement time and achieves a detection limit of 1 ug/dL according to our latest data.

Accordingly, there is a continuing need for a detection system that may more quickly determine the quantity of lead in capillary blood. Desirably, the detection system is easily implemented in point-of-care settings.

### SUMMARY

In concordance with the instant disclosure, a detection system that detects lead in capillary blood more quickly than known detection techniques, has surprisingly been discovered. Desirably, the detection system is tailored to be easily implemented in point-of-care locations. By utilizing X-ray fluorescence measurements, the present disclosure has the benefit of relying on easy-to-use non-destructive measurements that, importantly, may have a majority of the technical processing automated within the equipment itself. Allowing the deployment of the present disclosure may allow point-of-care measures more easily, which would also empower the measurement of traditionally difficult to assess communities using blood spot collections and the potential for mail-in sample measurements. The present disclosure itself would thus simultaneously allow for a solution that potentially allows for increased participation from communities without clinics for point-of-care assessments, while allowing for the continued use of point-of-care assessments taken on-site.

The detection system of the present disclosure utilizes x-ray fluorescence as a scalable, point-of-care test for widespread surveillance of blood lead with lower detection limits than ASV. The detection system includes an x-ray fluorescence device, an x-ray tube having an x-ray source and an anode, a silicon drift detector, a filter card, and a light source. In a specific example, the detection system may be utilized to measure blood lead by drying capillary blood on the filter card. In a more specific example, a higher-powered x-ray tube may be utilized in comparison to known detection methodologies. This increase in power may reduce the measurement time by a factor of the increase in power. The detection system of the present disclosure may include a limit of detection around <=5 ug/L. In a more specific example, the detection system may have a limit of detection around <=3 ug/L. In an even more specific example, the detection system may have a limit of detection around <=1 ug/L.

In certain circumstances, the detection system may include ways to simultaneously measure multiple elements and conditions for those measurements. Historically, simultaneous measurement of elements with overlapping signal quantification has been unreliable with XRF technologies. For example, Hg, As, Pb, and Cd are difficult to discern from each other given their overlapping signal quantification. Pb and As have overlapping signal quantification so under standard measurement conditions, this would be thought to introduce additional bias into the measurement. Similarly, Hg is close to Pb and As causing interference, and Cd has three additional elements with interference. Since the detection system is capable of detection limits as low as <=1 ug/L, a deconvolution procedure may be implemented in the detection system to differentiate these peaks while militating against further error introduction. In certain circumstances, the detection system may include a processor to conduct the deconvolution procedure. Desirably, this may enable broad surveillance of samples. One skilled in the art may select other suitable ways for simultaneously measuring multiple elements, within the scope of the present disclosure.

In certain circumstances, the detection system may include ways to analyze samples having varying volumes. In known dried blood spot analysis methods, a consistent blood spot volume is utilized to derive a calibration line to confirm the ability to measure the blood lead. These known methods also require the filter paper to be completely covered with blood to avoid any inaccuracies of measuring clean filter paper. However, the detection system of the present disclosure may further include a beam collimator to only measure a portion or portions of the filter paper that have blood. In other words, the beam collimator may advantageously be used to measure samples with lower volumes. In some circumstances, this may necessitate a modification of the beam aperture specific to the samples you are measuring. For example, some samples may measure 50-70 uL drops and use an 8 mm beam diameter to cover the spot without getting any additional filter paper in the measurement. Then, the detection system may then switch to measuring samples having 10 uL drops. To enhance the measurement of smaller volumes, the detection system of the present disclosure may use a lower beam diameter allowing enhanced consistency across changing volumes. Alternatively, the processor of the detection system may include a calibration procedure to account for the changing volumes. A skilled artisan may select other suitable methods of enabling smaller sample volumes and varying sample volumes, within the scope of the present disclosure.

In certain circumstances, the detection system of the present disclosure may be specifically configured to allow for measurements in water. For example, the detection system may measure forever chemicals such as perfluoroalkyl and polyfluoroalkyl substances (PFAS) in water. In a more specific example, the detection system may be specifically configured to detect Perfluorooctane sulfonate (PFOS). For instance, the detection system of the present disclosure may further include a vacuum chamber, a vacuum, and a light element detector. This may allow for the quantification of nearly every element from carbon up to uranium on the periodic table down to 1 ug/L. Importantly, by measuring total fluorine levels down to 1 ug/L, the present disclosure would enable a real time measurement that could be produced to give us an effective measure of potential PFAS and PFOS in water.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a box diagram of the components of a detection system, according to one embodiment of the present disclosure;

FIG. 2 is a plot diagram illustrating a comparison of XRF measured dried blood spots to GFAAS measured venous blood (n=22), according to one embodiment of the present disclosure;

FIG. 3A is a plot diagram illustrating XRF measurements of NIST 955c capillary blood with arsenic compared to known values to demonstrate capabilities of multi-element measurements and disentanglement of overlapping peaks, according to one embodiment of the present disclosure;

FIG. 3B is a plot diagram illustrating XRF measurements of NIST 955c capillary blood with lead compared to known values to demonstrate capabilities of multi-element measurements and disentanglement of overlapping peaks, according to one embodiment of the present disclosure;

FIG. 4 is a plot diagram illustrating the relationship between XRF lead counts (uncalibrated) and ICP-MS results of whole blood (n=23), according to one embodiment of the present disclosure;

FIG. 5 is a flowchart depicting a method for using a detection system, according to one embodiment of the present disclosure; and

FIG. 6 is a schematic diagram of the detection system, further depicting the system having a communication interface, an input interface, a user interface, and a system circuitry, wherein the system circuitry may include a processor and a memory, according to one embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

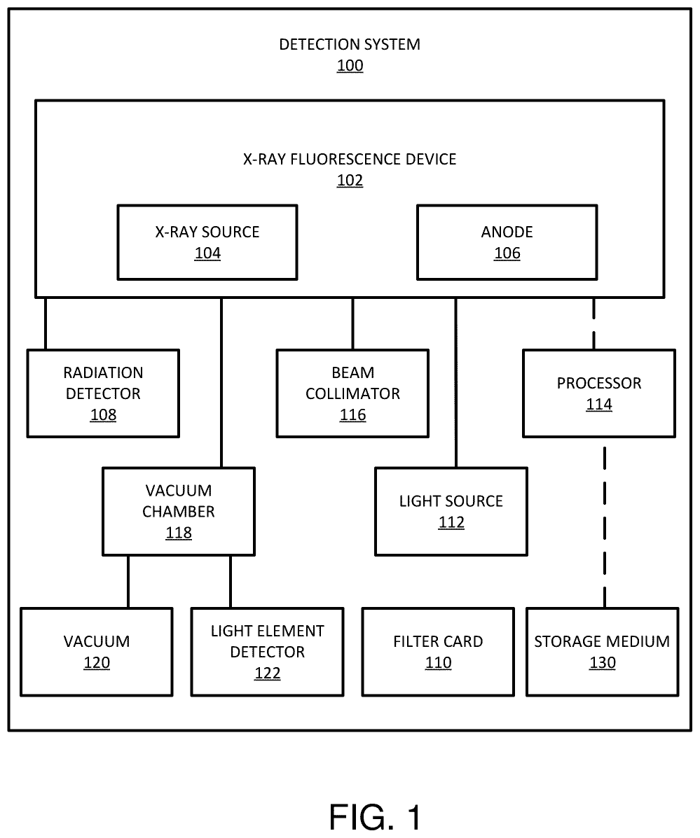

The detection system 100 of the present disclosure utilizes x-ray fluorescence as a scalable, point-of-care test for widespread surveillance of blood lead with lower detection limits than ASV. As shown in FIG. 1, the detection system 100 includes an x-ray fluorescence device 102, an x-ray tube 104, 106 having an x-ray source 104 and an anode 106, a radiation detector 108, a filter card 110, and a light source 112. The radiation detector 108 may include a silicon drift detector. In a specific example, the detection system 100 may be utilized to measure blood lead by drying capillary blood on the filter card 110. In a more specific example, a higher-powered x-ray tube 104, 106 may be utilized in comparison to known detection methodologies. This increase in power may reduce the measurement time by a factor of the increase in power. For instance, the detection system 100 of the present disclosure may provide the measurement having a <=5 ug/L detection limit within three to five minutes. The detection system 100 of the present disclosure may include a limit of detection around <=5 ug/L. In a more specific example, the detection system 100 may have a limit of detection around <=3 ug/L. In an even more specific example, the detection system 100 may have a limit of detection around <=1 ug/L. In a specific example, the detection system 100 of the present disclosure may continue to provide the measurement having the <=1 ug/L detection limit within three to five minutes.

In certain circumstances, the detection system 100 may include ways to simultaneously measure multiple elements and conditions for those measurements. Historically, simultaneous measurement of elements with overlapping signal quantification has been unreliable with XRF technologies. For example, Hg, As, Pb, and Cd are difficult to discern from each other given their overlapping signal quantification. Pb and As have overlapping signal quantification so under standard measurement conditions, this would be thought to introduce additional bias into the measurement. Similarly, Hg is close to Pb and As causing interference, and Cd has three additional elements with interference. Since the detection system 100 is capable of detection limits as low as <=1 ug/L, a deconvolution procedure may be implemented in the detection system 100 to differentiate these peaks while militating against further error introduction. In certain circumstances, the detection system 100 may include a processor 114 to conduct the deconvolution procedure. Desirably, this may enable broad surveillance of samples of all elemental content with no limitation based on the elements discussed here. The processor 114 may be coupled with the x-ray fluorescence device 102. For instance, the processor 114 may be electrically coupled and/or communicatively coupled to the x-ray fluorescence device 102. One skilled in the art may select other suitable ways for simultaneously measuring multiple elements, within the scope of the present disclosure.

In certain circumstances, the detection system 100 may include ways to analyze samples having varying volumes. In known dried blood spot analysis methods, a consistent blood spot volume is utilized to derive a calibration line to confirm the ability to measure the blood lead. These known methods also require the filter card 110 to be completely covered with blood to avoid any inaccuracies of measuring clean filter card 110. However, the detection system 100 of the present disclosure may further include a beam collimator 116 to only measure a portion or portions of the filter card 110 that have blood. In other words, the beam collimator 116 may advantageously be used to measure samples with lower volumes. In some circumstances, this may necessitate a modification of the beam aperture specific to the samples being measured. For example, some samples may measure 50-70 uL drops and use an 8 mm beam diameter to cover the spot without getting any additional filter card 110 in the measurement. The detection system 100 may then switch to measuring samples having 10 uL drops. To enhance the measurement of smaller volumes, the detection system 100 of the present disclosure may use a lower beam diameter allowing enhanced consistency across changing volumes. Alternatively, the processor 114 of the detection system 100 may include a calibration procedure to account for the changing volumes. A skilled artisan may select other suitable methods of enabling smaller sample volumes and varying sample volumes, within the scope of the present disclosure.

In certain circumstances, the detection system 100 of the present disclosure may be specifically configured to allow for measurements in water. For example, the detection system 100 may measure forever chemicals such as perfluoroalkyl and polyfluoroalkyl substances (PFAS) in water. In a more specific example, the detection system 100 may be specifically configured to detect Perfluorooctane sulfonate (PFOS). Currently, water service providers have no way of knowing whether there is an elevated amount of PFAS or PFOS in water at the treatment plant which has led to many negative news stories. The reason for this, is current measurement techniques require a lab analysis over the course of multiple hours or days in order to get a measurement. Water service providers often use a service where they send a sample out to and have result turnaround in around forty-eight hours.

Water service providers are all spending incredible amounts of money on this issue daily with no real time information on active PFAS in their water. They use activated carbon to reduce the PFAS to acceptable levels, but, since they have no way of knowing, they are throwing a standard amount of activated carbon in daily. This function is estimated to cost more than two thousand dollars per day. This is something that all water service providers have been dealing as an infrastructure bill to meet certain restrictions on PFAS and PFOS in water.

In a specific example, the detection system 100 of the present disclosure may further include a vacuum chamber 118, a vacuum 120, and a light element detector 122. The light element detector 122 may be disposed substantially transverse to the x-ray source 104. In a specific example, the light element detector 122 may be disposed at around a forty-five-degree angle from the x-ray source 104. Provided as a non-limiting example, the x-ray source 104 may be a 50 kVP tube that is operated at around 15 kV and around 0.13 milliamps. The vacuum chamber 118 may militate against any of the sample from touching the detector front. The vacuum chamber 118 may have one open terminal end open accommodate large sample screening. A pump may be utilized as the vacuum 120 to empty the vacuum chamber 118 of air. In a specific example, the pump 120 may be attached to the side of the detector 100 for use before measurements. In a specific example, the vacuum chamber 118 may include polypropylene sheets attached to allow for easy sealing with larger consumer products to be screened. For smaller items, an optional large vacuum chamber 118 made of acrylic may be used. The detection system 100 may be oriented downward at the object to be screened. A 10-minute measurement may be used to produce results with detection limits on the order of 10 part per billion. A skilled artisan may select other suitable ways of providing and materials for constructing the vacuum 120, the vacuum chamber 118, and the light element detector 122, within the scope of the present disclosure.

The utilization of the vacuum 120 with the light element detector 122 may allow for the quantification of nearly every element from carbon up to uranium on the periodic table down to 1 ug/L. Importantly, by measuring total fluorine levels down to 1 ug/L, the present disclosure would enable a real time measurement that could be produced to give us an effective measure of potential PFAS and PFOS in water. As previously mentioned, a standard lab analysis often takes multiple hours or days in order to get a measurement, whereas the detection system 100 of the present disclosure may provide a measurement on-site within ten minutes.

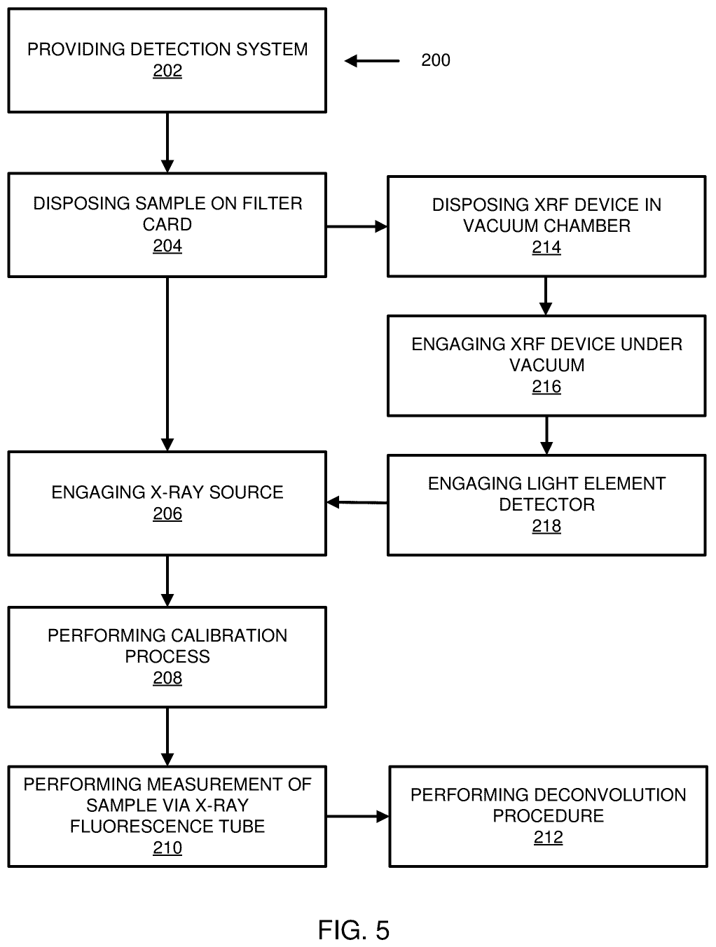

The detection system 100 may be provided in various ways. For instance, as shown in FIG. 5, the detection system 100 may be used according to a method 200 for elemental quantification. The method 200 may include a step 202 of providing an x-ray fluorescence device 102, an x-ray tube 104, 106 having an x-ray source 104 and an anode 106, a silicon drift detector 108, a filter card 110, and a light source 112. A sample may be disposed on the filter card 110. The x-ray source 104 may be engaged on the x-ray tube 104, 106. Afterwards, the x-ray fluorescence device 102 may perform a measurement of the sample. A skilled artisan may select other suitable methodologies for using the detection system 100, within the scope of the present disclosure.

In certain circumstances, the method 200 may further include providing a vacuum 120, a vacuum chamber 118, and a light element detector 122. Then, the detection system 100 may be disposed in the vacuum chamber 118. The light element detector 122 may be disposed substantially transverse to the x-ray source 104. A sample may be disposed substantially adjacent to the open terminal end of the vacuum chamber 118. The sample may then be measured by the detection system 100.

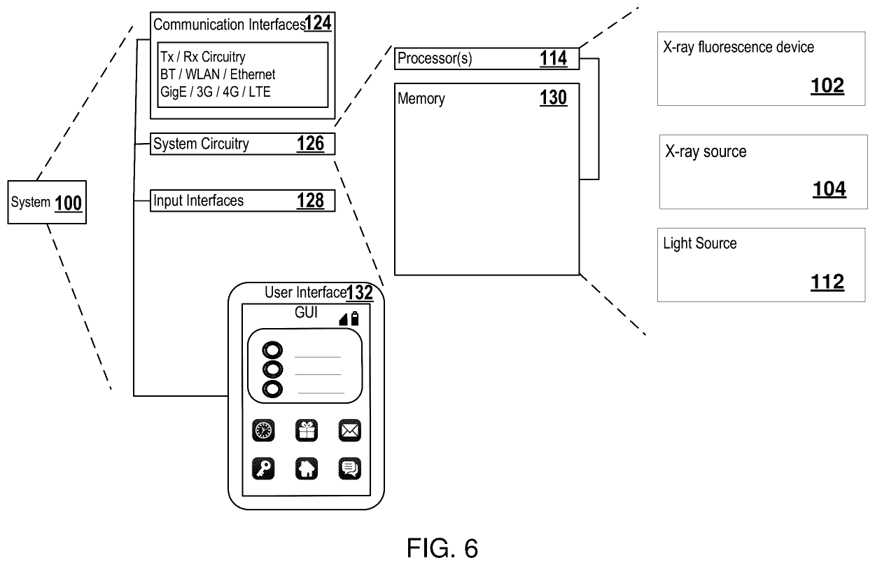

In certain circumstances, as shown in FIG. 6, the detection system 100 may further include a communication interface 124, a system circuitry 126, and/or an input interface 128. The system circuitry 126 may include the processor 114 or multiple processors. The processor 114 or multiple processors may execute the steps to engage the x-ray source 104 on the x-ray tube 104, 106 and perform a measurement of the sample. Alternatively, or in addition, the system circuitry 126 may include memory 130.

The processor 114 may be in communication with the memory 130. In some examples, the processor 114 may also be in communication with additional elements, such as the communication interfaces 124, the input interfaces 128, and/or a user interface 132. Examples of the processor 114 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 114 may be one or more devices operable to execute logic. The logic may include computer executable instructions or computer code stored in the memory 130 or in other memory that when executed by the processor 114, cause the processor 114 to perform the operations of the x-ray fluorescence device 102, the x-ray source 104, and the light source 112. In certain circumstances, the processor 114 may also perform the operations of the vacuum 120 and the light element detector 122. The computer code may include instructions executable with the processor 114.

The memory 130 may be any device for storing and retrieving data or any combination thereof. The memory 130 may include non-volatile and/or volatile memory, such as a random-access memory (RAM), a read-only memory (ROM), an erasable programmable read-only memory (EPROM), or flash memory. Alternatively or in addition, the memory 130 may include an optical, magnetic (hard-drive), solid-state drive or any other form of data storage device. The memory 130 may be included in any component or sub-component of the system described herein.

The user interface 132 may include any interface for displaying graphical information. The system circuitry 126 and/or the communications interface(s) may communicate signals or commands to the user interface 132 that cause the user interface 132 to display graphical information. Alternatively or in addition, the user interface 132 may be remote to the system and the system circuitry 126 and/or communication interface(s) 124 may communicate instructions, such as HTML, to the user interface 132 to cause the user interface 132 to display, compile, and/or render information content. In some examples, the content displayed by the user interface 132 may be interactive or responsive to user input. For example, the user interface 132 may communicate signals, messages, and/or information back to the communications interface or system circuitry 126.

The system may be implemented in many different ways. In some examples, the system may be implemented with one or more logical components. For example, the logical components of the system may be hardware or a combination of hardware and software. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 130, for example, which comprises instructions executable with the processor 114 or other processor to implement one or more of the features of the logical components. When any one of the logical components includes the portion of the memory 130 that comprises instructions executable with the processor 114, the component may or may not include the processor 114. In some examples, each logical component may just be the portion of the memory 130 or other physical memory that comprises instructions executable with the processor 114, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

Advantageously, the detection system 100 of the present disclosure may provide a scalable, point-of-care test for widespread surveillance of blood lead with lower detection limits than ASV. Desirably, by utilizing x-ray fluorescence detection methodologies, measurement durations less than ten minutes may be obtained.

### Example

Provided as a non-limiting example, the detection system 100 of the present disclosure was tested with the following characteristics. The PANalytical (Westborough, MA) Epsilon 4 measurement system was utilized, but improvements were made based on changing this instrumentation to meet the standards necessary for blood lead surveillance. The system 100 used for testing uses a silver anode x-ray tube 104, 106 up to 50 kV max energy with a max power output of 15 watts. Each instrument is equipped with a silicon drift detector 108 with a resolution of about 145 eV. Measurements were made for varying times from 30 to 60 minutes. For this testing, measurements of dried blood spots were completed by cutting out the entire spot using a cleaned 20 mm arc punch and placing the spot face down in a standard 32 mm XRF cup (Premier Lab Supply SC4131) with a 2.5 um Mylar film (SPEX SamplePrep 3518). Capillary blood NIST 955c standards were used for testing the system 100.

Calibration for the system 100 was done first via spiked DI water samples and with known NIST 955c capillary blood standards. Both results were shown to be acceptable for reproducing results from real dried blood spots. The same spotting procedures and materials were used for the water standards as was used for blood. 150 μL of ultra-pure type 1 DI water spiked with 0, 5, 10, 50, and 100 ug/dL of lead (Fisher Chemical, certified reference standard solution) was spotted on standard blood spot cards inside a clean room facility. Whatman 903 protein saver cards (GE Healthcare for Life Sciences) were used for spotting the standards and blood in this study.

Results from three sets of samples are presented for consideration of the limitations of the current device and identify the development needs for the future. First, we used blood from Boston Children's Hospital collected via venipuncture and confirmed via graphite furnace atomic absorption spectrometry (GFAAS). Second, we used the NIST standard 955c metals in capillary blood, which has 4 levels of lead and arsenic in increasing amounts at once. This would represent a worst-case scenario, as lead and arsenic have an overlapping peak and would need to be disentangled prior to proper quantification. Lastly, we had blood samples from mostly environmentally exposed individuals in a study from Boston with low levels of exposure and confirmed using inductively coupled plasma mass spectrometry.

An empirical detection limit was calculated from repeated measures of the same spot made from a 10 ug/dL lead standard and two blood samples measured via ICP-MS, with Pb concentrations of 7.1 and 5.5 ug/dL as measured by ICP-MS. The distribution of those repeated measurements is shown in Table 1, from which we calculated MDLs of 1.0, 1.0 and 3.2 ug/dL.

TABLE 1
Distribution of repeated 30-minute measurements of blood spots.

| | Number of | Concentration* | Coefficient | MDL |
|---|---|---|---|---|
| Sample | Measurements | (ug/dL) | of Variation | (ug/dL) |
| Blood Spot | 22 | 10 | 0.05 | 1.0 |
| Standard | | | | |
| Blood Spot | 20 | 5.5 | 0.09 | 1.0 |
| 1 (150 uL) | | | | |
| Blood Spot | 30 | 7.1 | 0.23 | 3.2 |
| 2 (300 uL) | | | | |

*As measured by ICP-MS.

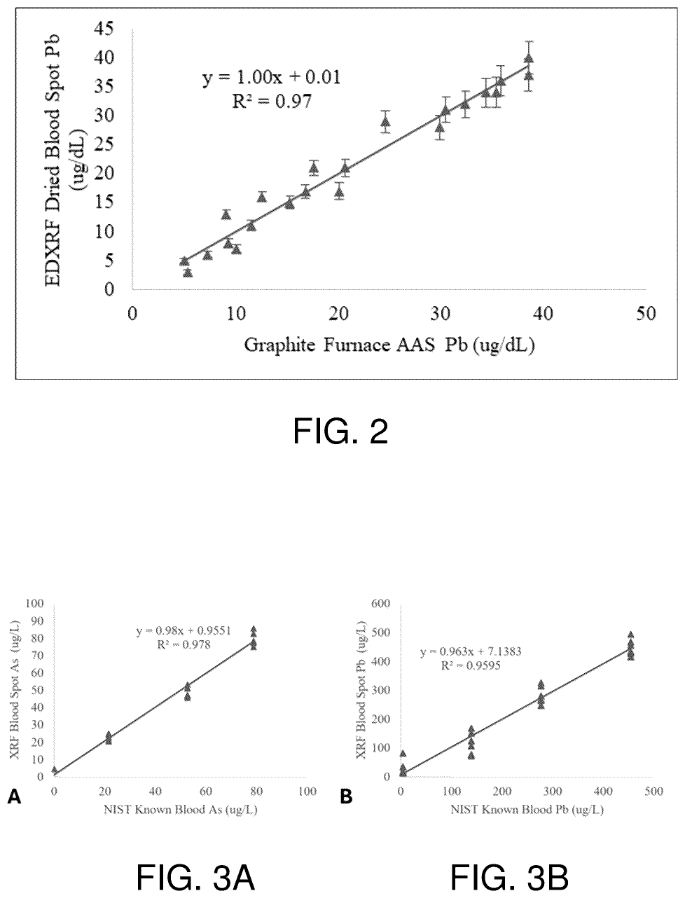

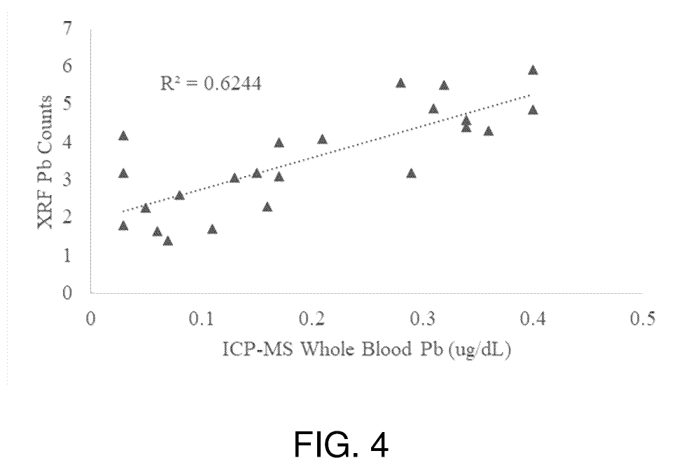

We have data from Boston Children's hospital compared to GFAAS in FIG. 2. We have measurements of the NIST 955c at 4 levels for both lead and arsenic in FIGS. 3A-3B. Finally, we have data from low level exposed adults in FIG. 4.

Thus, the current method works well for quantification of lead down to the levels necessary and will even produce results for measurements below the detection limit, which are very useful for large scale measurements. In addition, high measurements do not have the dependency that exists within ASV preventing accurate measurements. Thus, ultra-low and ultra-high values will have a demonstrated repeatable measurement accuracy.

The current measurements were done using primarily a 30-minute measurement time with a 60-minute measurement time for the lowest measurements in FIG. 4. In order to get this number to the required 5-minute measurement time for point-of-care assessment, the detection system 100 of the present disclosure may increase the x-ray tube 104, 106 power by the factor of decrease in time. In x-ray fluorescence, the certainty and statistics of a quantitative result is determined solely based on the counting statistics of the measurement itself. Thus, a longer counting time or a higher count rate would give the same results. Additionally, known detectors allow for much higher count rates in measurements of dried blood spots, as we are operating for the above measurements at 15 watts with 5% dead time. The optimal dead time for most measurements is approximately 50% with high throughput electronics on current detectors. 50-watt systems have been tested, which still only give us a maximum of 15% dead time with dried blood spots. Thus, the detection system 100 of the present disclosure may utilize a 50-watt or 100-watt system for optimal measurements that could be completed within 9 minutes (50-watt) to 4.5 minutes (100-watt). Importantly, increasing the wattage would not increase the required shielding around a stand of the device and would not require any additional considerations in terms of power consumption, such as special electric connections. Finally, since XRF can give real-time results while measuring data, the detection system 100 may impose a solution where the XRF will read out the data at a certain level of accuracy given the individual blood it is currently measuring. For blood with a relatively high amount of lead, say around 10 ug/dL, the detection system 100 may produce results in less than 5-minutes but use additional time depending on if the user was in a situation where there was no test to be run immediately after.

The error produced within an XRF can be produced for each measurement. This would allow the user to determine if the current measurement was viable or not. Additionally, since this is a multi-element approach, the iron signal may be used, which should be considerably less variable than lead, for determination of whether there was user error within the collection protocol prior to insertion in the XRF for measurement.

In conclusion, the detection system 100 of the present disclosure may have the ability to measure dried blood spots with a minimum detection limit of 1 ug/dL with a measurement time of 5-10 minutes. Solutions with capacity for singular measurements or with a sample chamber for larger-scale operations are also contemplated. One could effectively utilize the detection system 100 for calibrated measures of soil, paint, toys, or consumer goods and, upon returning to the stand, resume blood lead testing.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A detection system configured for elemental quantification, the detection system comprising:
an x-ray fluorescence (XRF) device having an x-ray tube including an x-ray source and an anode, the x-ray source produces an x-ray beam;
a filter card disposed along a path of the x-ray beam; and
a radiation detector coupled to the XRF device.

2. The detection system of claim 1, further comprising a storage medium and a processor, the storage medium storing processor-executable instructions, the storage medium communicatively coupled to the XRF device, the processor is electrically coupled to the storage medium.

3. The detection system of claim 1, wherein the detection system has a detection limit<=5 ug/L.

4. The detection system of claim 2, wherein the processor includes a deconvolution procedure which enables the simultaneous measurement of different elements with overlapping signal quantification.

5. The detection system of claim 2, further comprising a beam collimator to measure only a portion of the filter card.

6. The detection system of claim 5, wherein the processor includes a calibration procedure to account for an array of sample volumes.

7. The detection system of claim 1, further comprising a vacuum chamber, a vacuum pump, and a light element detector.

8. The detection system of claim 7, wherein the light element detector is disposed substantially transverse to the x-ray source.

9. The detection system of claim 7, wherein the vacuum chamber includes an open terminal end.

10. The detection system of claim 7, wherein the vacuum chamber is constructed with a polypropylene sheet.

11. The detection system of claim 7, wherein the vacuum chamber is constructed with an acrylic material.

12. The detection system of claim 7, wherein the detection system detects the presence of perfluorooctane sulfonate (PFOS) in a solution within ten minutes.

13. The detection system of claim 1, wherein a power of the x-ray tube is at least around fifty watts.

14. The detection system of claim 13, wherein the power of the x-ray tube is around one-hundred watts.

15. A method of using a detection system configured for elemental quantification, the method comprising the steps of:
providing the detection system including an x-ray fluorescence (XRF) device, a filter card, and a radiation detector, the XRF device having an x-ray tube including an x-ray source and an anode, the x-ray source configured to produce an x-ray beam, the filter disposed along a path of the x-ray beam, and the radiation detector coupled to the XRF device;
disposing a sample on the filter card;
engaging the x-ray source on the x-ray tube; and
performing a measurement of the sample via the detection system.

16. The method of claim 15, further comprising a step of disposing the XRF device in a vacuum chamber before the step of engaging the x-ray source.

17. The method of claim 16, further comprising a step of engaging the XRF device under a vacuum.

18. The method of claim 17, further comprising a step of engaging a light element detector while the XRF device is engaged.

19. The method of claim 15, further comprising a step of performing a deconvolution procedure using a processor coupled with the XRF device.

20. The method of claim 15, further comprising a step of performing a calibration procedure via a processor coupled with the XRF device.
